(19) United States
(12) Patent Application Publication
(10) Pub. No.: US 2013/0224571 A1
(43) Pub. Date: Aug. 29, 2013

(54) LITHIUM ION SECONDARY BATTERY AND METHOD FOR MANUFACTURING THE SAME

(71) Applicants: Hideaki Sasaki, Tokyo (JP); Takehiro Noguchi, Tokyo (JP)

(72) Inventors: Hideaki Sasaki, Tokyo (JP); Takehiro Noguchi, Tokyo (JP)

(73) Assignee: NEC CORPORATION, Tokyo (JP)

(21) Appl. No.: 13/880,849

(22) PCT Filed: Nov. 2, 2011
(86) PCT No.: PCT/JP2011/075310

§ 371 Date: Apr. 22, 2013

(30) Foreign Application Priority Data
Dec. 13, 2010 (JP) 2010-276937

(51) Int. Cl. H01M 10/0561; H01M 10/052

(52) U.S. Cl. CPC H01M 10/0561; H01M 10/052
USPC 429/163; 429/188; 29/623.1

(57) ABSTRACT

A lithium ion secondary battery including: a positive electrode including a positive electrode active material represented by the general formula: Liₐ(MₓMn_{2-x-y}A_{y})O₄ wherein 0.4<x, 0≦y, x+y<2, and 0≦a 2≦hold, M represents one or two or more metals selected from the group consisting of Ni, Co, and Fe and including at least Ni, and A represents at least one element selected from the group consisting of B, Mg, Al, and Ti; a negative electrode including a negative electrode active material capable of intercalating and deintercalating lithium; a nonaqueous electrolytic solution; and a lithium ion type zeolite in contact with this nonaqueous electrolytic solution.

### TECHNICAL FIELD

The present invention relates to a lithium ion secondary battery and a method for manufacturing the same.

### BACKGROUND ART

Lithium ion secondary batteries have smaller volume or higher weight capacity density than other secondary batteries, such as alkali storage batteries, and moreover, high voltage can be obtained. Therefore, lithium ion secondary batteries are widely employed as power supplies for small size equipment, and widely used particularly as power supplies for mobile equipment, such as cellular phones and notebook computers. In addition, in recent years, other than small-sized mobile equipment uses, applications to large size batteries for which large capacity and long life are required, such as in electric vehicles (EV) and the power storage field, have been expected because of consideration for environmental problems, and an increase in awareness of energy saving.

In currently commercially available lithium ion secondary batteries, as a positive electrode active material, those based on LiMO₂ (M is at least one of Co, Ni, and Mn) of layer structure or LiMn₂O₄ of spinel structure are used, and as a negative electrode active material, carbon materials, such as graphite, are used. Such batteries mainly have a charge and discharge region of 4.2 V or less (versus lithium potential).

On the other hand, Patent Literatures 1 and 2 disclose techniques for adsorbing and removing moisture and other impurities contained in an electrolyte, using a lithium ion type zeolite, in order to suppress the deterioration of the performance of a lithium battery.

### CITATION LIST

### Patent Literature

Patent Literature 1: JP59-81869A

Patent Literature 2: JP07-262999A

### SUMMARY OF INVENTION

### Technical Problem

With respect to the battery having a charge and discharge region of 4.2 V or less (versus lithium potential) described above, a battery using a positive electrode material obtained by replacing part of Mn in LiMn₂O₄ by Ni or the like can have a charge and discharge region as high as 4.5 to 4.8 V (versus lithium potential). In a battery using, for example, a spinel compound represented by LiNi_{0.5}Mn_{1.5}O₄, as a positive electrode material, the oxidation-reduction between Mn³⁺ and Mn⁴⁺ is not utilized, Mn is present in the state of Mn⁴⁺, and the oxidation-reduction between Ni²⁺and Ni⁴⁺is utilized. Therefore, the battery exhibits an operating voltage as high as 4.5 V or more. An electrode using such a spinel compound is referred to as a “5 V class positive electrode,” and can promote an improvement in energy density by higher voltage, and therefore is expected as a promising positive electrode.

However, there is a problem that when the potential of the positive electrode increases, the following phenomena tend to occur: the electrolytic solution is oxidatively decomposed to produce gases; by-products accompanying the decomposition of the electrolytic solution are produced; metal ions, such as Mn and Ni, in the positive electrode active material are eluted and deposited on the negative electrode to accelerate the deterioration of the negative electrode, and the like. As a result, the cycle deterioration of the battery increases. In particular, in a battery using the 5 V class positive electrode, since the potential of the positive electrode is high, the above phenomena tend to occur, and the adverse effect of metal ions eluted from the positive electrode, and impurities, such as by-products accompanying the decomposition of the electrolytic solution, on battery characteristics may be larger.

It is an object of the present invention to provide a lithium ion secondary battery with improved cycle characteristics and high energy density, and a method for manufacturing the same.

### Solution to Problem

One aspect of the present invention provides a lithium ion secondary battery including:

a positive electrode including a positive electrode active material represented by the following general formula (I):

Liₐ(MₓMn_{2-x-y}A_{y})O₄ (I)

wherein 0.4<x, 0≦y, x+y<2, and 0≦a≦2 hold, M represents one or two or more metals selected from the group consisting of Ni, Co, and Fe and including at least Ni, and A represents at least one element selected from the group consisting of B, Mg, Al, and Ti;

a negative electrode including a negative electrode active material capable of intercalating and deintercalating lithium;

a nonaqueous electrolytic solution; and

a lithium ion type zeolite in contact with the nonaqueous electrolytic solution.

Another aspect of the present invention provides a method for manufacturing a lithium ion secondary battery, including:

forming a positive electrode including a positive electrode active material represented by the following general formula (I):

Liₐ(MₓMn_{2-x-y}A_{y})O₄ (I)

wherein 0.4<x, 0≦y, x+y<2, and 0≦a≦2 hold, M represents one or two or more metals selected from the group consisting of Ni, Co, and Fe and including at least Ni, and A represents at least one element selected from the group consisting of B, Mg, Al, and Ti;

forming a negative electrode including a negative electrode active material capable of intercalating and deintercalating lithium; and

bringing a nonaqueous electrolytic solution into contact with a lithium ion type zeolite.

### Advantageous Effect of Invention

According to an exemplary embodiment of the present invention, a lithium ion secondary battery with improved cycle characteristics and high energy density can be obtained.

### DESCRIPTION OF EMBODIMENT

An exemplary embodiment of the present invention will be described below.

### Basic Configuration of Battery

A lithium ion secondary battery according to this exemplary embodiment includes a positive electrode containing a positive electrode active material capable of intercalating and deintercalating lithium, a negative electrode containing a negative electrode active material capable of intercalating and deintercalating lithium, and a nonaqueous electrolytic solution, and can further include a separator and a package. The positive electrode and the negative electrode can be disposed opposed to each other via the separator. A stack including the positive electrode, the negative electrode, and the separator disposed in this manner can be sealed with the package with the nonaqueous electrolytic solution contained.

The positive electrode can include a positive electrode current collector and a positive electrode active material layer on this current collector, and the negative electrode can include a negative electrode current collector and a negative electrode active material layer on this current collector.

Such a lithium ion secondary battery can further include a lithium ion type zeolite in such a manner that the lithium ion type zeolite is in contact with the electrolytic solution, or as the electrolytic solution, an electrolytic solution subjected to adsorption treatment with a lithium ion type zeolite can be used.

### Nonaqueous Electrolytic Solution

The nonaqueous electrolytic solution can comprise a supporting salt and a nonaqueous solvent that dissolves this supporting salt.

Examples of the supporting salt include lithium imide salts and lithium salts, such as LiPF₆, LiAsF₆, LiAlCl₄, LiClO₄, LiBF₄, and LiSbF₆. Examples of the lithium imide salts include LiN(CₖF₂ₖ₊₁SO₂)(CₘF₂ₘ₊₁SO₂) (k and m are each independently 1 or 2). One supporting salt can be used alone, or two or more supporting salts can also be used in combination. Among these, LiPF₆ and LiBF4 are preferred.

As the nonaqueous solvent, at least one type of organic solvent selected from cyclic carbonates, chain carbonates, aliphatic carboxylates, γ-lactones, cyclic ethers, and chain ethers can be used.

Examples of the cyclic carbonates include propylene carbonate (PC), ethylene carbonate (EC), butylene carbonate (BC), and derivatives thereof (including fluorides). Generally, the viscosity of cyclic carbonates is high, and therefore, the cyclic carbonates can be used by mixing chain carbonates in order to reduce the viscosity.

Examples of the chain carbonates include dimethyl carbonate (DMC), diethyl carbonate (DEC), ethyl methyl carbonate (EMC), dipropyl carbonate (DPC), and derivatives thereof (including fluorides).

Examples of the aliphatic carboxylates include methyl formate, methyl acetate, ethyl propionate, and derivatives thereof (including fluorides).

Examples of the γ-lactones include γ-butyrolactone and derivatives thereof (including fluorides).

Examples of the cyclic ethers include tetrahydrofuran, 2-methyltetrahydrofuran, and derivatives thereof (including fluorides).

Examples of the chain ethers include 1,2-ethoxyethane (DEE), ethoxymethoxyethane (EME), diethyl ether, and derivatives thereof (including fluorides).

As other nonaqueous solvents, dimethyl sulfoxide, 1,3-dioxolane, formamide, acetamide, dimethylformamide, dioxolane, acetonitrile, propionitrile, nitromethane, ethyl monoglyme, phosphate triester, trimethoxymethane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propane sultone, anisole, N-methylpyrrolidone, and derivatives thereof (including fluorides) can also be used.

The concentration of the lithium salt can be set, for example, in the range of 0.5 mol/L to 1.5 mol/L.

### Lithium ion Type Zeolite

A zeolite has a skeleton structure in which silicon (Si) is bonded to aluminum (Al) via oxygen (O). In this skeleton structure, the aluminum (+3 valence) and the silicon (+4 valence) share the oxygen (−2 valence) each other. Accordingly, the periphery of the silicon is electrically neutral, and the periphery of the aluminum is −1-valent, and a cation in the skeleton structure compensates for this negative charge. A Na type zeolite in which this cation is a Na ion (Na⁺) is common. A zeolite exhibits ion exchange action because this cation can be easily exchanged for another metal ion or the like. In addition, in the zeolite, various molecules, such as water and organic molecules, can be adsorbed in pores in a three-dimensional skeleton formed by the three-dimensional combination of a structure of Si—O—Al—O—Si, according to the size of the pores.

However, in an ordinary zeolite, cations (Na ions and the like) in the zeolite are ion-exchanged for Li ions, Mn ions, and the like in an electrolytic solution, and released into the electrolytic solution, and due to the effect of these released cations, battery characteristics may decrease. Therefore, a Li ion type zeolite obtained by replacing cations in a zeolite by Li ions is preferably used. In this exemplary embodiment, a lithium ion type zeolite obtained by replacing Na ions contained in a Na type zeolite by Li ions (Li⁺) can be used. The lithium ion type zeolite can be prepared by an ordinary ion exchange method, and can be obtained, for example, by treating a Na type zeolite in an organic solvent containing 20 to 50% by mass of a lithium salt, such as lithium chloride, to ion-exchange Na ions for Li ions. In order to increase the lithium ion exchange rate, such treatment may be repeated a plurality of times. A higher lithium ion exchange rate is better. From the viewpoint of sufficiently suppressing the effect of the elution of cations (Na ions and the like), other than lithium ions, in the zeolite, the lithium ion exchange rate is preferably 70% or more, more preferably 80% or more, and more preferably 90% or more. From the viewpoint of the efficiency and cost of ion exchange treatment, a zeolite with a lithium ion exchange rate of 99% or less may be used, and further, a zeolite with a lithium ion exchange rate of 98% or less may be used.

Here, the lithium ion exchange rate is obtained from the atomic ratio of Li ions in a zeolite introduced by ion exchange to other cations in the zeolite (Li ions/(Li ions+cations)), and can be expressed in percentage. For example, when Na ions in a Na type zeolite are exchanged for Li ions, the lithium ion exchange rate is obtained from the atomic ratio of Li ions to Na ions in the zeolite (Li ions/(Li ions+Na ions)). The amounts of cations, such as Li ions, Na ions, and K ions, contained in a zeolite can be quantified by an ICP (inductively coupled plasma)-atomic emission spectroscopy method, an atomic absorption spectrometry method, or the like.

As such a zeolite, those having various crystal structures, such as an A type, an X type, and a Y type, can be used.

The pore diameter of a zeolite is determined by its crystal structure. A Zeolite with a pore diameter smaller than the effective diameter of the solvent of the electrolytic solution can be used. In addition, when an additive is added to the electrolytic solution for the formation of an SEI film, or the like, this pore diameter is preferably smaller than the effective diameter of this additive. Such a zeolite can efficiently adsorb moisture in the solvent. From such a viewpoint, for example, a zeolite with a pore diameter of 0.5 nm or less can be used. On the other hand, in terms of sufficiently adsorbing moisture, a zeolite with a pore diameter of 0.3 nm or more can be used. The pore diameter of a zeolite can be obtained by measuring an adsorption isotherm by a gas adsorption method using argon, and analyzing it. As such a zeolite, for example, an A type zeolite can be used.

Examples of the form of the application of a lithium ion type zeolite to a battery include the following.

(1) An electrolytic solution in which a powdery zeolite is dispersed and suspended is prepared, and a battery is formed using this electrolytic solution.

(2) An electrolytic solution is previously pretreated with a zeolite, and a battery is formed using this pretreated electrolytic solution (which does not contain the zeolite). It is possible to disperse and suspend a powdery zeolite in this pretreated electrolytic solution to prepare the electrolytic solution of the above (1), and form a battery using the electrolytic solution.

(3) A zeolite is housed in the space between a package and an electrode stack including a positive electrode and a negative electrode. For example, the zeolite can be housed in a space around the electrode stack. For an electrolytic solution at this time, the electrolytic solution of the above (1) may be used, or the electrolytic solution of the above (2) may be used.

Among these, in the application form (1), impurities eluted into the electrolytic solution with a battery reaction can be more efficiently adsorbed.

The zeolite powder preferably has a moderate average particle diameter from the viewpoint of the property of adsorbing impurities in the solution, and accommodation in the battery. In particular, considering dispersibility in the electrolytic solution and reliability, the average particle diameter of the zeolite powder is preferably 10 μm or less, more preferably 5 μm or less. If the average particle diameter of the zeolite powder is too large, the zeolite powder settles immediately in the electrolytic solution, and therefore, it is difficult to obtain a uniform suspension. In addition, the possibility that a failure, such as the zeolite powder breaking through the separator (particularly one with a thickness of about 20 to 30 nm), occurs increases. However, in the case of the application form (3), the average particle diameter is not particularly limited as long as the size is such that the zeolite powder can be housed in the space between the electrode stack and the package (for example, a space around the electrode stack in the length direction of the electrode stack [a plane direction perpendicular to the thickness direction of the electrode stack]) without hindrance. The average particle diameter may be 10 μm or more. On the other hand, considering the handling properties of the zeolite powder and the controllability of the particle diameter of the zeolite powder, and the like, the average particle diameter of the zeolite powder is preferably 0.1 μm or more, more preferably 0.5 μm or more, and further preferably 1 μm or more.

Here, the average particle diameter can be defined as a particle diameter (D₅₀) when the cumulative volume of particles is 50% in a particle size distribution curve. This average particle diameter can be measured by a laser diffraction scattering method (Microtrac method).

The application form (2) is a method in which impurities in an electrolytic solution are previously adsorbed by a lithium ion type zeolite before the electrolytic solution is injected into a battery. The application form (2) is particularly effective when there are large amounts of impurity components in an electrolytic solution before injection into a battery.

According to the application form (3), part of the lithium ion type zeolite can be in contact with the electrolytic solution, and the remainder can be in contact with gas components produced in the battery. The application form (3) is a method effective in adsorbing gas components produced in a battery reaction, in addition to the removal of impurities in the electrolytic solution.

These application forms (1) to (3) may be appropriately selected according to the purity of the electrolytic solution before injection into the battery, and the amounts of impurities and gases produced by a battery reaction, and these methods can also be combined.

The content of the above lithium ion type zeolite is preferably 0.01% by mass or more, more preferably 0.05% by mass or more, and further preferably 0.1% by mass or more, based on the nonaqueous electrolytic solution in terms of obtaining a more sufficient addition effect, and is preferably 10% by mass or less, more preferably 5% by mass or less, and further preferably 1% by mass or less, from the viewpoint of charge and discharge capacity per unit weight, and cost reduction.

### Positive Electrode Active Material

As the positive electrode active material, a lithium manganese complex oxide represented by the following general formula (I) and having a discharge potential of 4.5 V (vs. Li/Li⁺) or more versus metal lithium can be used.

Liₐ(MₓMn_{2-x-y}A_{y})O₄ (I)

wherein 0.4<x, 0≦y, x+y<2, and 0≦a≦2 hold, M represents one or two or more metals selected from the group consisting of Ni, Co, and Fe and including at least Ni, and A represents at least one element selected from the group consisting of B, Mg, Al, and Ti.

M in formula (I) includes Ni alone, or includes Ni as the main component and includes at least one of Co and Fe. The atomic ratio of Ni in M (Ni/(Ni+Co+Fe)) is preferably 0.4 or more, more preferably 0.5 or more, and further preferably 0.6 or more. There are other metals exhibiting a discharge potential of 4.5 V or more, such as Cr and Cu, but by using a lithium manganese complex oxide represented by formula (I), including at least Ni, the desired secondary battery can be obtained.

A in formula (I) includes at least one selected from B, Mg, Al, and Ti. Such a replacement element A can mainly stabilize the structure of the active material, and can improve battery life. Other replacement elements, such as Na, Si, K, and Ca, may be also used, but by using a lithium manganese complex oxide represented by formula (I), including at least one selected from B, Mg, Al, and Ti, the desired secondary battery can be obtained.

For the positive electrode active material, those satisfying 0.4<x in formula (I) can be preferably used, and further, those satisfying 0.5≦x can be used. In addition, those satisfying x≦1.2 can be used, and further, those satisfying x<0.7 can be used.

In formula (I), a is the ratio of Li when the total ratio of the elements M, Mn, and A of (MₓMn_{2-x-y}A_{y}) is 2, and a satisfies 0≦a≦2, preferably 0≦a≦1.2, and more preferably 0≦a≦1. As the material of the positive electrode active material, those satisfying 0<a≦1.2 can be used, and further, those satisfying 0.8<a<1.2 can be used.

In this exemplary embodiment using the lithium ion type zeolite, the positive electrode active material represented by the above general formula (I) is particularly suitable as the active material of a 5 V class positive electrode. This is probably because the types and amounts of metal ions eluted from a positive electrode active material are different due to a difference in composition, that is, because the ability of the lithium ion type zeolite to adsorb impurities is specifically preferred for a battery using the particular positive electrode active material represented by general formula (I).

For the positive electrode active material, particulate ones with an average particle diameter (D₅₀) of 5 to 25 μm can be used. If the particle diameter is too small, the reactivity with the electrolytic solution increases, and the life characteristics may decrease. On the contrary, if the particle diameter is too large, the migration of lithium ions is slow, and the rate characteristics may decrease. Here, the average particle diameter (D₅₀) can be defined as a particle diameter when the cumulative volume of particles is 50% in a particle size distribution curve. This average particle diameter can be measured by a laser diffraction scattering method (Microtrac method).

### Negative Electrode Active Material

The negative electrode active material is not particularly limited as long as it is a material capable of intercalating and deintercalating lithium ions. Carbon materials, such as graphite and amorphous carbon, can be used. From the viewpoint of energy density, graphite is preferably used. As other negative electrode active materials, materials forming alloys with Li, such as Si, Sn, and Al, Si oxides, Si complex oxides containing Si and a metal element other than Si, Sn oxides, Sn complex oxides containing Sn and a metal element other than Sn, Li₄Ti₅O₁₂, composite materials obtained by coating these materials with carbon, and the like can also be used. One negative electrode active material can be used alone, or two or more negative electrode active materials can also be used in combination.

For the negative electrode active material, particulate ones with an average particle diameter (D₅₀) of 5 to 35 μm can be used. If the particle diameter is too small, the reactivity with the electrolytic solution increases, and the life characteristics may decrease. On the contrary, if the particle diameter is too large, the migration of lithium ions is slow, and the rate characteristics may decrease. Here, the average particle diameter (D₅₀) can be defined as a particle diameter when the cumulative volume of particles is 50% in a particle size distribution curve. This average particle diameter can be measured by a laser diffraction scattering method (Microtrac method).

### Electrode

For the positive electrode, those in which a positive electrode active material layer is formed on at least one surface of a positive electrode current collector can be used. The positive electrode active material layer contains a positive electrode active material as the main material, and can contain a binder and a conductive aid. For the negative electrode, those in which a negative electrode active material layer is formed on at least one surface of a negative electrode current collector can be used. The negative electrode active material layer contains a negative electrode active material as the main material, and can contain a binder and a conductive aid. In each electrode, for the content of the active material in the active material layer, 80% by mass or more of the active material is preferably contained based on the total of materials forming the active material layer in terms of obtaining the desired battery characteristics.

As the binder, resin binders, such as polyvinylidene fluoride (PVDF) and acrylic polymers, can be used for the positive electrode and the negative electrode. Examples of the binder used in the negative electrode include, other than the above, styrene butadiene rubber (SBR). When a water-based binder, such as an SBR-based emulsion, is used, a thickening agent, such as carboxymethyl cellulose (CMC), can also be used.

As the conductive aid, carbon materials, such as carbon black, particulate graphite, scaly graphite, and carbon fibers, can be used for the positive electrode and the negative electrode. In particular, in the positive electrode, carbon black with low crystallinity is preferably used.

As the positive electrode current collector, foil, flat plates, and meshes made of aluminum, stainless steel, nickel, titanium, or alloys thereof, or the like can be used. As the negative electrode current collector, foil, flat plates, and meshes made of copper, stainless steel, nickel, titanium, or alloys thereof, or the like can be used.

When a conductivity-providing agent is used, the amount of the conductivity-providing agent added can be appropriately set, and, for example, can be set in the range of 1 to 10% by mass based on the total of materials forming the active material layer.

The amount of the binder added can be appropriately set, and, for example, can be set in the range of 1 to 10% by mass based on the total of materials forming the active material layer.

The positive electrode and the negative electrode can be formed, for example, as follows. An active material, a binder, and a conductive aid in predetermined amounts blended are dispersed and kneaded in a solvent, such as N-methyl-2-pyrrolidone (NMP), to obtain a slurry. This slurry was applied to a current collector and dried to form an active material layer. The obtained electrode can also be adjusted to appropriate density by compressing it by a method such as roll pressing.

### Separator

As the separator, porous films made of polyolefins, such as polypropylene and polyethylene, fluororesins, and the like can be used.

### Package

The package can be formed using packaging materials used in ordinary lithium ion secondary batteries, and, for example, cans, such as a coin type, a prismatic type, and a cylindrical type, and laminate packages can be used. From the viewpoint of enabling weight reduction and promoting an improvement in battery energy density, a laminate package using a flexible film composed of a laminate of a synthetic resin and metal foil is preferred. A laminate type battery using such a laminate package is also excellent in heat dissipation properties, and therefore preferred as a vehicle-mounted battery for electric vehicles and the like.

### Method for Manufacturing Lithium Ion Secondary Battery

The lithium ion secondary battery according to this exemplary embodiment can be manufactured, for example, as follows.

First, in dry air or an inert atmosphere, a positive electrode and a negative electrode are disposed opposed to each other via a separator to form an electrode stack.

On the other hand, a nonaqueous electrolytic solution in which a lithium ion type zeolite is suspended and mixed, or a nonaqueous electrolytic solution subjected to adsorption treatment using a lithium ion type zeolite is prepared.

Next, the electrode stack is accommodated in a package, and the nonaqueous electrolytic solution is injected. Then, the package is sealed.

A lithium ion type zeolite can also be provided in the space between the electrode stack and the package before the package, in which the electrode stack is accommodated, is sealed.

### EXAMPLES

The present invention will be described in detail below by giving Examples, but the present invention is not limited to the following Examples.

### Example 1

### Making of Negative Electrode

A graphite powder (average particle diameter (D₅₀): 20 μM specific surface area: 1.2 m²/g) as a negative electrode active material, and PVDF as a binder were prepared. These were added and mixed in N-methyl-2-pyrrolidone (NMP) at a mass ratio of 95:5 (black powder:PVDF), and uniformly dispersed to make a negative electrode slurry.

This negative electrode slurry was applied to 15 μm thick copper foil (negative electrode current collector), and then dried at 125° C. for 10 minutes to evaporate the NMP. Then, the applied layer on the copper foil was pressed to obtain a negative electrode in which a negative electrode active material layer was provided on the copper foil. The weight of the negative electrode active material layer per unit area after the drying and pressing was 0.008 g/cm².

### Making of Positive Electrode

A LiNi_{0.5}Mn_{1.5}O₄ powder (average particle diameter (D₅₀): 10 μm, specific surface area: 0.5 m²/g) as a positive electrode active material was prepared. This positive electrode active material, PVDF as a binder, and carbon black as a conductive aid were added and mixed in NMP at a mass ratio of 93:4:3 (active material:PVDF:carbon black), and uniformly dispersed to make a positive electrode slurry.

This positive electrode slurry was applied to 20 μm thick aluminum foil (positive electrode current collector), and then dried at 125° C. for 10 minutes to evaporate the NMP to obtain a positive electrode in which a positive electrode active material layer was provided on the aluminum foil. The weight of the positive electrode active material layer per unit area after the drying was 0.018 g/cm².

### Lithium Ion Type Zeolite

A 3A type zeolite (lithium ion type zeolite) with an average particle diameter of 3 μm and a lithium ion exchange rate of 96% was prepared.

### Nonaqueous Electrolytic Solution

A nonaqueous electrolytic solution in which 1 mol/L of LiPF₆ was dissolved in a nonaqueous solvent in which ethylene carbonate (EC) and dimethyl carbonate (DMC) were mixed at a volume ratio of 40:60 (EC:DMC) was prepared. 0.2% by mass of the above lithium ion type zeolite based on this nonaqueous electrolytic solution was added to the nonaqueous electrolytic solution, and dispersed and suspended using ultrasonic waves.

### Making of Laminate Type Battery

Each of the positive electrode and the negative electrode made as described above was cut into a size of 5 cm×6 cm. A 5 cm×1 cm portion along one side of each electrode was a portion (uncoated portion) in which the electrode active material layer was not formed in order to connect a tab, and a portion in which the electrode active material layer was formed was 5 cm×5 cm.

A width 5 mm×length 3 cm×thickness 0.1 mm aluminum positive electrode tab was ultrasonically welded to the uncoated portion of the positive electrode with a length of 1 cm. In addition, a nickel negative electrode tab with the same size as the positive electrode tab was ultrasonically welded to the uncoated portion of the negative electrode in a similar manner.

Next, a separator made of polyethylene and polypropylene with a size of 6 cm×6 cm was prepared. The above negative electrode and positive electrode were disposed on both surfaces of this separator so that the electrode active material layers were opposed to each other across the separator, to obtain an electrode stack.

Next, two aluminum laminate films with a size of 7 cm×10 cm were prepared. For these films, three sides excluding one of the long sides were adhered with a width of 5 mm by heat sealing to make a bag-shaped laminate package.

Next, the above electrode stack was inserted into the laminate package. At this time, the electrode stack was inserted so that one side of the electrode stack was disposed at a distance of 1 cm from one short side of the laminate package.

Next, 0.2 g of the above nonaqueous electrolytic solution was injected to vacuum-impregnate the electrode stack with the nonaqueous electrolytic solution. Then, the opening was sealed with a width of 5 mm by heat sealing under reduced pressure to obtain a laminate type battery.

### Initial Charge and Discharge

The laminate type battery made as described above was charged at 20° C. at a constant current of 12 mA corresponding to a 5 hour rate (0.2 C) to 4.8 V, then subjected to 4.8 V constant voltage charge (total charge time including charge time until 4.8 V was reached: 8 hours), and then subjected to constant current discharge at 60 mA corresponding to a 1 hour rate (1 C) to 3.0 V.

### Cycle Test

A charge and discharge cycle in which the laminate type battery after the completion of the initial charge and discharge was charged at 1 C to 4.8 V, then subjected to 4.8 V constant voltage charge (total charge time including charge time until 4.8 V was reached: 2.5 hours), and then subjected to constant current discharge at 1 C to 3.0 V was repeated 200 times at 45° C. The ratio of discharge capacity after 200 cycles to initial discharge capacity was calculated as a capacity retention rate (%).

### Example 2

A battery was made and evaluated by methods similar to those of Example 1 except that LiNi_{0.4}Co_{0.2}Mn_{1.4}O₄ was used as the positive electrode active material.

### Example 3

A battery was made and evaluated by methods similar to those of Example 1 except that LiNi_{0.4}Fe_{0.2}Mn_{1.4}O₄ was used as the positive electrode active material.

### Example 4

A battery was made and evaluated by methods similar to those of Example 1 except that LiNi_{0.5}Mn_{1.35}Ti_{0.15}O₄ was used as the positive electrode active material.

### Example 5

A battery was made and evaluated by methods similar to those of Example 1 except that LiNi_{0.5}Mn_{1.42}Mg_{0.08}O₄ was used as the positive electrode active material.

### Example 6

A battery was made and evaluated by methods similar to those of Example 1 except that LiNi_{0.5}Mn_{1.42}Al_{0.08}O₄ was used as the positive electrode active material.

### Example 7

A battery was made and evaluated by methods similar to those of Example 1 except that LiNi_{0.5}Mn_{1.44}B_{0.06}O₄ was used as the positive electrode active material.

### Example 8

A battery was made and evaluated by methods similar to those of Example 1 except that LiNi_{0.5}Mn_{1.32}Ti_{0.1}Mg_{0.08}O₄ was used as the positive electrode active material.

### Example 9

A battery was made and evaluated by methods similar to those of Example 1 except that LiNi_{0.5}Mn_{1.32}Ti_{0.1}Al_{0.08}O₄ was used as the positive electrode active material.

### Example 10

A battery was made and evaluated by methods similar to those of Example 1 except that LiNi_{0.45}Fe_{0.1}Mn_{1.35}Ti_{0.1}O₄ was used as the positive electrode active material.

### Comparative Example 1

A battery was made and evaluated by methods similar to those of Example 1 except that the nonaqueous electrolytic solution to which the lithium ion type zeolite was not added was used.

### Comparative Example 2

A battery was made and evaluated by methods similar to those of Example 1 except that LiNi_{0.45}Cr_{0.1}Mn_{1.45}O₄ was used as the positive electrode active material.

### Comparative Example 3

A battery was made and evaluated by methods similar to those of Example 1 except that

LiNi_{0.4}Cu_{0.1}Mn_{1.5}O₄ was used as the positive electrode active material.

### Comparative Example 4

A battery was made and evaluated by methods similar to those of Example 1 except that LiNi_{0.5}Mn_{1.42}Na_{0.08}O₄ was used as the positive electrode active material.

### Comparative Example 5

A battery was made and evaluated by methods similar to those of Example 1 except that LiNi_{0.5}Mn_{1.42}Si_{0.08}O₄ was used as the positive electrode active material.

### Comparative Example 6

A battery was made and evaluated by methods similar to those of Example 1 except that LiNi_{0.5}Mn_{1.42}K_{0.08}O₄ was used as the positive electrode active material.

Comparative Example 7

A battery was made and evaluated by methods similar to those of Example 1 except that LiNi_{0.5}Mn_{1.42}Ca_{0.08}O₄ was used as the positive electrode active material.

The compositions of the positive electrode active material and the capacity retention rate after 200 cycles (%) for the batteries of Examples 1 to 10 and Comparative Examples 1 to 7 are shown in Table 1.

In the batteries of Examples 1 to 10 using the nonaqueous electrolytic solution to which the lithium ion type zeolite was added, and using a positive electrode active material having a composition represented by general formula (I), the capacity retention rate was as high as 60% or more. On the other hand, in the battery of Comparative Example 1 in which the lithium ion type zeolite was not added to the nonaqueous electrolytic solution, and the batteries of Comparative Examples 2 to 7 using the nonaqueous electrolytic solution to which the lithium ion type zeolite was added, but using a positive electrode active material not having a composition represented by general formula (I), the capacity retention rate was as low as about 50%.

TABLE 1

| | Composition of positive electrode active | | | Capacity |
|---|---|---|---|---|
| | material | | | retention |
| | M | A | Liₐ(MₓMn_{2-x-y}A_{y})O₄ | rate (%) |
| Example 1 | Ni | — | LiNi_{0.5}Mn_{1.5}O₄ | 60 |
| Example 2 | Ni, Co | — | LiNi_{0.4}Co_{0.2}Mn_{1.4}O₄ | 61 |
| Example 3 | Ni, Fe | — | LiNi_{0.4}Fe_{0.2}Mn_{1.4}O₄ | 62 |
| Example 4 | Ni | Ti | LiNi_{0.5}Mn_{1.35}Ti_{0.15}O₄ | 65 |
| Example 5 | Ni | Mg | LiNi_{0.5}Mn_{1.42}Mg_{0.08}O₄ | 65 |
| Example 6 | Ni | Al | LiNi_{0.5}Mn_{1.42}Al_{0.08}O₄ | 64 |
| Example 7 | Ni | B | LiNi_{0.5}Mn_{1.44}B_{0.06}O₄ | 60 |
| Example 8 | Ni | Ti, Mg | LiNi_{0.5}Mn_{1.32}Ti_{0.1}Mg_{0.08}O₄ | 67 |
| Example 9 | Ni | Ti, Al | LiNi_{0.5}Mn_{1.32}Ti_{0.1}Al_{0.08}O₄ | 65 |
| Example 10 | Ni, Fe | Ti | LiNi_{0.45}Fe_{0.1}Mn_{1.35}Ti_{0.1}O₄ | 63 |
| Comparative | Ni | — | LiNi_{0.5}Mn_{1.5}O₄ | 47 |
| Example 1 | | | | |
| Comparative | Ni, Cr | — | LiNi_{0.45}Cr_{0.1}Mn_{1.45}O₄ | 51 |
| Example 2 | | | | |
| Comparative | Ni, Cu | — | LiNi_{0.4}Cu_{0.1}Mn_{1.5}O₄ | 50 |
| Example 3 | | | | |
| Comparative | Ni | Na | LiNi_{0.5}Mn_{1.42}Na_{0.08}O₄ | 44 |
| Example 4 | | | | |
| Comparative | Ni | Si | LiNi_{0.5}Mn_{1.42}Si_{0.08}O₄ | 48 |
| Example 5 | | | | |
| Comparative | Ni | K | LiNi_{0.5}Mn_{1.42}K_{0.08}O₄ | 45 |
| Example 6 | | | | |
| Comparative | Ni | Ca | LiNi_{0.5}Mn_{1.42}Ca_{0.08}O₄ | 44 |
| Example 7 | | | | |

### Example 11

A battery was made and evaluated by methods similar to those of Example 4 except that a lithium ion type zeolite with a lithium ion exchange rate of 70% was used.

### Example 12

A battery was made and evaluated by methods similar to those of Example 4 except that a lithium ion type zeolite with a lithium ion exchange rate of 80% was used.

### Example 13

A battery was made and evaluated by methods similar to those of Example 4 except that a lithium ion type zeolite with a lithium ion exchange rate of 90% was used.

### Example 14

A battery was made and evaluated by methods similar to those of Example 4 except that a lithium ion type zeolite with a lithium ion exchange rate of 94% was used.

The capacity retention rate after 200 cycles (%) and the lithium ion exchange rate of the lithium ion type zeolite for the batteries of Examples 11 to 14 are shown in Table 2. As the lithium ion exchange rate increases, the capacity retention rate increases. In particular, at 90% or more, a high capacity retention rate is obtained.

TABLE 2

| | Lithium ion | Capacity |
|---|---|---|
| | exchange | retention |
| | rate (%) | rate (%) |
| Example 11 | 70 | 54 |
| Example 12 | 80 | 60 |
| Example 13 | 90 | 64 |
| Example 14 | 94 | 65 |

### Example 15

A nonaqueous electrolytic solution in which 1 mol/L of LiPF₆ was dissolved in a nonaqueous solvent in which ethylene carbonate (EC) and dimethyl carbonate (DMC) were mixed at a volume ratio of 40:60 (EC:DMC) was prepared. A 3A type zeolite (lithium ion type zeolite) with an average particle diameter of 3 μm and a lithium ion exchange rate of 96% wrapped and enclosed in a polyethylene nonwoven fabric was placed in this nonaqueous electrolytic solution, allowed to stand at room temperature for 1 week, and then removed. The amount of the lithium ion type zeolite used was 5% by mass based on the nonaqueous electrolytic solution.

A battery was made and evaluated by methods similar to those of Example 4 except that this nonaqueous electrolytic solution subjected to pretreatment was used without adding the lithium ion type zeolite.

### Example 16

A nonaqueous electrolytic solution in which 1 mol/L of LiPF₆ was dissolved in a nonaqueous solvent in which EC and DMC were mixed at a volume ratio of 40:60 (EC:DMC) was prepared. This nonaqueous electrolytic solution was injected into the battery, and then, 2% by mass of the above lithium ion type zeolite based on the nonaqueous electrolytic solution was placed in the space between the electrode stack and the laminate package (space around the electrode stack). At this time, part of the lithium ion type zeolite was in the state of being in contact with the electrolytic solution.

A battery was made and evaluated by methods similar to those of Example 4 except that the lithium ion type zeolite was placed in the space as described above, and was not added to the nonaqueous electrolytic solution.

### Example 17

The pretreatment of the nonaqueous electrolytic solution was performed by the same method as Example 15, and then, 0.2% by mass of the above lithium ion type zeolite was added to this nonaqueous electrolytic solution, and dispersed and suspended using ultrasonic waves.

A battery was made and evaluated by methods similar to those of Example 4 except that this nonaqueous electrolytic solution was used.

### Example 18

A battery was made and evaluated using the nonaqueous electrolytic solution in which the lithium ion type zeolite was dispersed and suspended, according to methods similar to those of Example 4 except that 2% by mass of the lithium ion type zeolite based on the nonaqueous electrolytic solution was placed in the space between the electrode stack and the laminate package according to methods similar to those of Example 16.

The capacity retention rate (%) after 200 cycles in Examples 15 to 18 is shown in Table 3.

In the batteries of all Examples, a capacity retention rate of 60% or more was obtained. In particular, the capacity retention rate of the batteries of Examples 17 and 18 using the nonaqueous electrolytic solution in which the lithium ion type zeolite was dispersed and suspended was high. This is probably because impurities produced in the batteries during the cycle test can be efficiently adsorbed and removed.

TABLE 3

| | | Capacity |
|---|---|---|
| | | retention |
| | Form of application of zeolite | rate (%) |
| Example 15 | Pretreatment of electrolytic | 61 |
| | solution | |
| Example 16 | Enclosing between electrode stack | 60 |
| | and package | |
| Example 17 | Pretreatment of electrolytic | 66 |
| | solution, and mixing and | |
| | dispersion in electrolytic | |
| | solution | |
| Example 18 | Mixing and dispersion in | 66 |
| | electrolytic solution, and | |
| | enclosing between electrode stack | |
| | and package | |

While the present invention has been described with reference to the exemplary embodiments and the Examples, the present invention is not limited to the above exemplary embodiments and Examples. Various modifications that can be understood by those skilled in the art may be made to the constitution and details of the present invention within the scope thereof.

This application claims the right of priority based on Japanese Patent Application No. 2010-276937, filed on Dec. 13, 2010, the entire disclosure of which is incorporated herein by reference.

1. A lithium ion secondary battery comprising:
a positive electrode comprising a positive electrode active material represented by the following general formula (I):
Liₐ(MₓMn_{2-x-y}A_{y})O₄ (I)
wherein 0.4<x, 0≦y, x+y<2, and 0≦a≦2 hold, M represents one or two or more metals selected from the group consisting of Ni, Co, and Fe and including at least Ni, and A represents at least one element selected from the group consisting of B, Mg, Al, and Ti;
a negative electrode comprising a negative electrode active material capable of intercalating and deintercalating lithium;
a nonaqueous electrolytic solution; and
a lithium ion type zeolite in contact with the nonaqueous electrolytic solution.

2. The lithium ion secondary battery according to claim 1, wherein a lithium ion exchange rate of the lithium ion type zeolite is 70% or more.

3. The lithium ion secondary battery according to claim 1, wherein a lithium ion exchange rate of the lithium ion type zeolite is 90% or more.

4. The lithium ion secondary battery according to claim 1, wherein 0.01 to 10% by mass of the lithium ion type zeolite based on the nonaqueous electrolytic solution is contained.

5. The lithium ion secondary battery according to claim 1, wherein the lithium ion type zeolite is suspended and mixed in the nonaqueous electrolytic solution, and housed in the battery.

6. The lithium ion secondary battery according to claim 1, further comprising:
a separator disposed between the positive electrode and the negative electrode; and
a package containing an electrode stack comprising the positive electrode, the negative electrode, and the separator, wherein
the lithium ion type zeolite is housed between the electrode stack and the package.

7. The lithium ion secondary battery according to claim 1, wherein the lithium ion type zeolite is an A type zeolite.

8. The lithium ion secondary battery according to claim 1, wherein in the positive electrode active material, an atomic ratio of Ni in M (Ni/(Ni+Co+Fe)) is 0.4 or more.

9. The lithium ion secondary battery according to claim 1, wherein the positive electrode active material has a discharge potential of 4.5 V or more versus metal lithium.

10. The lithium ion secondary battery according to claim 1, wherein in the formula (I), 0<a≦1.2 holds.

11. A method for manufacturing a lithium ion secondary battery, comprising:
forming a positive electrode comprising a positive electrode active material represented by the following general formula (I):
Liₐ(MₓMn_{2-x-y}A_{y})O₄ (I)
wherein 0.4<x, 0≦y, x+y<2, and 0≦a≦2 hold, M represents one or two or more metals selected from the group consisting of Ni, Co, and Fe and including at least Ni, and A represents at least one element selected from the group consisting of B, Mg, Al, and Ti;
forming a negative electrode comprising a negative electrode active material capable of intercalating and deintercalating lithium; and
bringing a nonaqueous electrolytic solution into contact with a lithium ion type zeolite.
